(19) United States
(12) Patent Application Publication
(10) Pub. No.: US 2026/0327047 A1
(43) Pub. Date: Oct. 22, 2026

(54) INSTALLING A HEAVY LIFT CRANE SYSTEM AT A HOISTING SITE

(71) Applicant: Itrec B.V., SCHIEDAM (NL)

(72) Inventor: Adrianus VAN DER LINDE, SCHIEDAM (NL)

(73) Assignee: Itrec B.V., SCHIEDAM (NL)

(21) Appl. No.: 19/104,623

(22) PCT Filed: Aug. 16, 2023
(86) PCT No.: PCT/EP2023/072512

§ 371 Date: Feb. 18, 2025

(30) Foreign Application Priority Data
Aug. 19, 2022 (NL) 2032809

(51) Int. Cl. B66C 23/36; B66C 23/74

(52) U.S. Cl. CPC B66C 23/365; B66C 23/74; B66C 2700/0371

(57) ABSTRACT

Method for installing a heavy lift crane system at a hoisting site. The crane system includes a circular slew track assembly extending over at least a slew arc about a slew center and a crane with a crane carriage configured to travel over the track arrangement, a main boom, a back mast, an adjustable length arrangement between the back mast and the main boom. The method includes arranging a connector strut underneath the horizontal back mast, pivotally connecting an upper end of the connector strut, pivoting the back mast into an inclined raised position, arranging a counterweight at the slew center, bringing the connector strut into a substantially vertical orientation above the counterweight, connecting a lower end of the connector strut to the counterweight, and raising the main boom.

### FIELD OF THE INVENTION

The present invention relates to the field of heavy lift crane systems.

### BACKGROUND OF THE INVENTION

In the field of heavy lifting crane systems are known, e.g. as disclosed in WO2010/121134, WO2019/050405. An example of a heavy lifting mobile crane system is the SK10,000 crane system that has been developed by the company ALE.

In WO2021/140011 a heavy lift crane system is disclosed. This crane system has a track arrangement configured to be installed on the ground. The arrangement includes a circular slew track assembly that extends over at least a slew arc about a slew center. The crane has a crane carriage with a base, a first chassis, and second chassis. The first and second chassis are configured to travel over the track arrangement and to support the base thereon. A main boom of the crane is pivotal relative to the base of the crane carriage about a main boom pivot axis and has a main boom tip. A back mast is pivotal relative to the base of the crane carriage about a back mast pivot axis and has a back mast tip. An adjustable length arrangement is provided between the back mast and the main boom. The crane has a counterweight that is arranged at the slew center. A connector strut of the crane serves to suspend the counterweight from the back mast. As is known in the art, the counterweight may then still rest on the ground or another support. A swivel is provided between the counterweight and the back mast to allow for slew motion of the crane about the slew center, e.g. the swivel being integrated with the connector strut.

These cranes are in practice so large that the crane is commonly assembled at the location of the hoisting job, e.g. at a refinery, a power plant, a production/assembly location of (offshore) wind turbines, etc. Commonly the main boom and the back mast are each assembled from modules, e.g. latticed modules. For example, the main boom and/or back mast are embodied as an A-frame. Other designs are also known, e.g. a main boom with parallel boom legs connected by brace members.

The track arrangement, in embodiments, may comprise load spreading boards on which the tracks are mounted, so that loads are distributed in view of the allowable ground pressure. In another design, the track arrangement is mounted on a foundation, e.g. for a more permanent (longer duration) use of the crane at one site.

In practice, the main boom, possibly extended by a jib, may be over 100 meters long. A tall main boom, e.g. including a jib, is for example envisaged for wind turbine assembly.

### SUMMARY OF THE INVENTION

The present invention aims to enhance the installation process of a heavy lift crane system. The crane system comprising:
a track arrangement configured to be installed on the ground and comprising:
   a circular slew track assembly extending over at least a slew arc about a slew center,
a crane comprising:
   a crane carriage, comprising a base, a first chassis and second chassis, the first and second chassis being configured to travel over the track arrangement and to support the base thereon,
   a main boom, that is pivotal relative to the base of the crane carriage about a main boom pivot axis, and has a main boom tip,
   a back mast, that is pivotal relative to the base of the crane carriage about a back mast pivot axis, and has a back mast tip,
   an adjustable length arrangement between the back mast and the main boom,
   a counterweight, that is configured to be arranged at the slew center,
      wherein the crane comprises a connector strut to suspend the counterweight from the back mast, and wherein a swivel is provided between the counterweight and the back mast to allow for slew motion of the crane about the slew center.

The present invention provides a method comprising the steps of:
installing the circular slew track assembly at the hoisting site,
assembly of the crane comprising:
   installing the crane carriage on the track arrangement,
   assembly of the main boom in horizontal orientation to the crane carriage,
   assembly of the back mast in horizontal orientation to the crane carriage,
   providing the adjustable length arrangement between the back mast and the main boom,
   arranging the connector strut, in a horizontal orientation, underneath the horizontal back mast,
   pivotally connecting an upper end of the connector strut to the horizontal back mast,
   pivoting the back mast into an inclined raised position with the connector strut being pivotally connected at its upper end to the back mast via a strut pivot axis,
   arranging the counterweight at the slew center,
   bringing the connector strut above the counterweight,
   connecting a lower end of the connector strut to the counterweight,
   raising the main boom.

The circular slew track assembly is installed at the hoisting site. This can be a full circle slew track, a semi-circular slew track, or a track extending over another arc segment, e.g. just more or less than half a circle. The center of the slew track forms the slew center of the crane.

The slew track can be configured to be deployed at various locations, as the crane system is used at these locations for hoisting jobs. The slew track can also be permanent, e.g. when the crane system is to be used at one location over a prolonged period. For example, the slew track can be mounted on a foundation, e.g. of concrete.

The assembly of the crane comprises installing the crane carriage on the track arrangement. If only the circular slew track assembly is present, the carriage is installed thereon. In case of a more complex track arrangement, e.g. as in WO2021/140011, the carriage could also be installed on the rectilinear track assembly, as discussed therein. Yet, in many situations, the track arrangement will only consist of the circular slew track assembly.

The main boom is assembled in a horizontal orientation thereof to the crane carriage. As discussed, the main boom will in practical embodiments be modular, and assembled from (many) main boom segments, e.g. as in WO2021/140011. For example, the main boom is an A-frame. In practical embodiments the horizontal main boom will rest on ground supports that hold the main boom horizontal and at a distance above the ground, e.g. the assembly of the main boom takes place on the ground supports. A jib may be fitted to the tip end of the main boom.

The back mast is assembled in horizontal orientation thereof to the crane carriage. As discussed, the back mast will in practical embodiments be modular, and assembled from (many) back mast segments, e.g. as in WO2021/140011. For example, the back mast is an A-frame. In practical embodiments the horizontal back mast will rest on ground supports that hold the back mast horizontal and at a distance above the ground, e.g. the assembly of the back mast takes place on the ground supports.

The adjustable length arrangement is provided between the back mast and the main boom. As, for example, described in WO2021/140011, this arrangement may comprise one or more winch driven cables, e.g. in multiple-fall arrangements between associated sheaves, between the back mast and the boom, e.g. between the back mast tip and the main boom tip. Possibly, the arrangement comprises a dedicated mechanism of winch(es) and cable(s) between the back mast that is solely used for raising of the main boom (e.g. with jib), this mechanism not being of use during normal operation of the crane.

Due to the inventive approach, the connector strut can be effectively handled. This connector strut is a crucial component of significant dimensions (in particular length) and mass, and may be assembly from strut components that are secured end-to-end. The strut may have multiple parallel strut components.

In a practical embodiment, it is envisaged that the connector strut is moved underneath the still horizontal back mast, e.g. using one or more vehicles, e.g. self-propelled modular transporters. In another approach, the assembly of the connector strut is done underneath the still horizontal back mast.

In a practical embodiment, before moving or assembling the connector strut underneath the back mast, ground supports upon which the back mast rests are first removed or displaced to clear the area for the connector strut. In a practical embodiment, the adjustable length arrangement is operated, e.g. tensioned, so that the back mast no longer rests on the ground supports and is effectively suspended, albeit in horizontal position, by this adjustable length arrangement.

During an installation configuration the connector strut is arranged horizontally underneath the horizontal back mast. The upper end of the connector strut is then pivotally connected to the back mast, e.g. to the tip end of the back mast, about a strut pivot axis.

In an operational configuration, after which the back mast is pivoted into an inclined raised position, the connector strut, which is pivotally connected to the back mast, e.g. to the tip end of the back mast, hangs in a substantially vertical orientation. The counterweight is connected to a lower end of the connector strut and thereby suspended from the back mast.

The connector strut moves from a horizontal to a substantially vertical position during pivoting of the back mast into an inclined position. As the back mast is raised the tip end of the back mast is elevated. Since the connector strut is pivotally connected and allowed to rotate along the pivot axis defined by the pivotal connection, the orientation of the connector strut is changed. This change of orientation is for example instigated by a gravitational force pulling on it or a drive guiding the rotation of the connector strut.

In an embodiment, a temporarily fastening is then arranged and/or operated to secure the connector strut along the back mast. This allows to raise the connector strut by the process step of pivoting the back mast into a raised position thereof. For example, the temporarily fastening involves the use of an auxiliary winch of the crane system and a corresponding winch driven cable that extends from the back mast and that is attached to the connector strut remote from its upper end, e.g. at or near its lower end. The cable can be used to pull the connector strut towards the back mast. Other approaches to provide a temporary fastening, e.g. involving the use of slings, locking devices, etc. are also envisaged.

Pivoting the back mast into the raised position can be done, in embodiments, using the adjustable length arrangement. Other approaches, e.g. including a dedicated upending mechanism for the back mast, are also envisaged.

In another embodiment, the connector strut is—after pivotally connecting the upper end of the connector strut to the horizontal back mast—supported at a lower end thereof by a vehicle, wherein the method then comprises:
pivoting the back mast into an inclined raised position, wherein the lower end of the connector strut initially remains supported by the vehicle that moves away from the slew track assembly until the lower end of the connector strut is lifted off the vehicle,
arranging the counterweight at the slew center,
bringing the connector strut in a substantially vertical orientation above the counterweight,
connecting the lower end of the connector strut to the counterweight,
raising the main boom, e.g. by operating the adjustable length arrangement between the back mast and the main boom.

Herein, the vehicle can be one that has been employed in moving the connector strut in position underneath the horizontal back mast.

In a further development of this approach—before pivoting the back mast into the inclined raised position—the lower end of the connector strut is connected via a sling or cable to the back mast, thereby limiting the pivot angle of the connector strut relative to the back mast, and wherein the method then comprises:
pivoting the back mast into an inclined raised position, preferably by operating the adjustable length arrangement between the back mast and the main boom, wherein the lower end of the connector strut initially remains supported by the vehicle that moves away from the slew track assembly until the lower end of the connector strut is lifted off the vehicle as the sling or cable limits the pivot angle of the connector strut,
arranging the counterweight at the slew center,
bringing the connector strut in a substantially vertical orientation above the counterweight, e.g. by pivoting the back mast,
connecting the lower end of the connector strut to the counterweight,
raising the main boom, e.g. by operating the adjustable length arrangement between the back mast and the main boom.

As the back mast in its horizontal orientation effectively extends over the slew center, the phase of arranging the counterweight at the slew center can readily be performed once the back mast is in this raised position, so that the connector strut is clear from the location where the counterweight is to be arranged.

The phase of arranging the counterweight may involve the assembly of the counterweight from components, e.g. steel plates, containers filled with ballast material, etc.

Once the counterweight has been completed, the connector strut is brought into position that allows for connection of the lower end thereof to the counterweight. For example, the connector strut is released from the back mast so that the strut can swing about its pivotal connection to a more or less vertical orientation, e.g. completely vertical orientation. In view of the dimension and mass of the connector strut an auxiliary winch and corresponding cable may be employed to cause a controlled swing of the connector strut.

The lower end of the connector strut is then connected to the counterweight. Once this situation has been reached, the main boom—possibly with jib arrangement at the tip end thereof—can be raised by operating the adjustable length arrangement between the back mast and the main boom.

The inventive installation process is effective and dependable.

In an embodiment, horizontal main boom rests on ground supports that hold the main boom horizontal and at a distance above the ground, e.g. the assembly of the main boom takes place on the ground supports and/or the horizontal back mast rests on ground supports that hold the back mast horizontal and at a distance above the ground, e.g. the assembly of the back mast takes place on the ground supports.

In an embodiment, before moving or assembling the connector strut underneath the back mast, ground supports upon which the back mast rests are first removed or displaced to clear an area for the connector strut. For example, the adjustable length arrangement is operated so that the back mast no longer rests on the ground supports and is effectively suspended, in horizontal position, by the adjustable length arrangement, the ground supports then be displaced or removed to clear an area under the horizontal back mast for the connector strut.

In an embodiment, the temporarily fastening involves the use of an auxiliary winch of the crane system and a corresponding winch driven cable that extends from the back mast and that is attached to the connector strut remote from its upper end, e.g. at or near its lower end, wherein the cable is used to retain the connector strut along the back mast, e.g. to pull the connector strut towards, e.g. against, the back mast.

In an embodiment, an auxiliary winch and corresponding cable is employed to cause a controlled swing of the connector strut 80 away from the back mast, e.g. the winch is used for temporarily fastening the connector strut.

The present invention also relates to a heavy lift crane system to be installed at a hoisting site.

### BRIEF DESCRIPTION OF THE DRAWINGS

The invention will now be discussed with reference to the drawings. In the drawings:

FIG. 1 shows an example of the installation of a heavy lift crane system according to the invention, wherein the crane is arranged on the circular slew track assembly,

FIG. 2 shows the crane of FIG. 1 in side view,

FIG. 3 illustrates the installing of the crane carriage on the circular slew track assembly, and the assembly of the main boom in horizontal orientation to the crane carriage,

FIG. 4 illustrates the assembly of the back mast in horizontal orientation to the crane carriage, and providing the adjustable length arrangement between the back mast and the main boom,

FIG. 5 illustrates tensioning the adjustable length arrangement and removal of the supports from underneath the still horizontal back mast,

FIG. 6 illustrates the arranging of the connector strut underneath the horizontal back mast, the pivotally connecting of an upper end of the connector strut to the horizontal back mast, and the temporarily fastening the connector strut along the back mast,

FIG. 7 illustrates the pivoting the back mast into an inclined raised position by operating the adjustable length arrangement between the back mast and the main boom,

FIG. 8 illustrates the arranging of the counterweight at the slew center, the undoing of the temporarily fastening the connector strut and causing the connector strut to swing to a substantially vertical orientation, followed by connecting a lower end of the connector strut to the counterweight,

FIG. 9 illustrates another embodiment for the arranging of the connector strut underneath the horizontal back mast, and the pivotally connecting of an upper end of the connector strut to the horizontal back mast,

FIG. 10 illustrates, following the FIG. 9, the pivoting the back mast into an inclined raised position by operating the adjustable length arrangement between the back mast and the main boom,

FIG. 11 illustrates, following the FIG. 10, the arranging of the counterweight at the slew center, bringing the connector strut above the counterweight, followed by connecting a lower end of the connector strut to the counterweight.

### DEATILED DESCRIPTION OF THE PREFFERED EMBODIMENTS

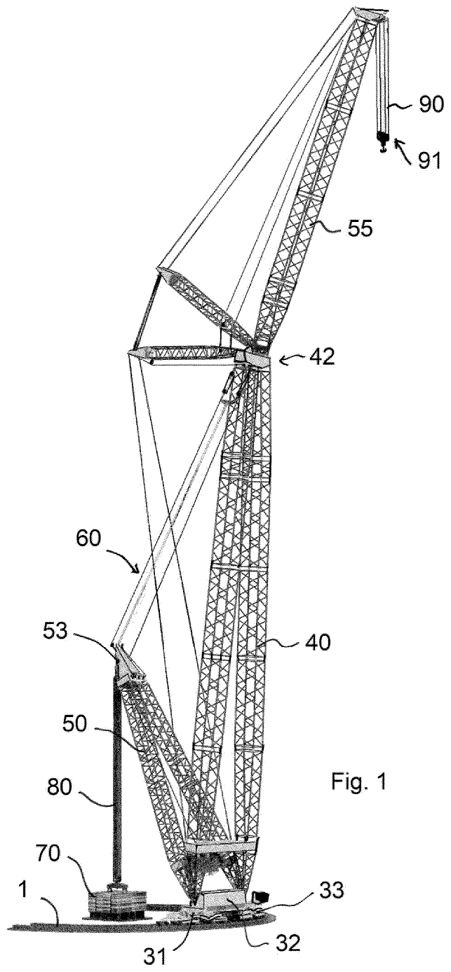

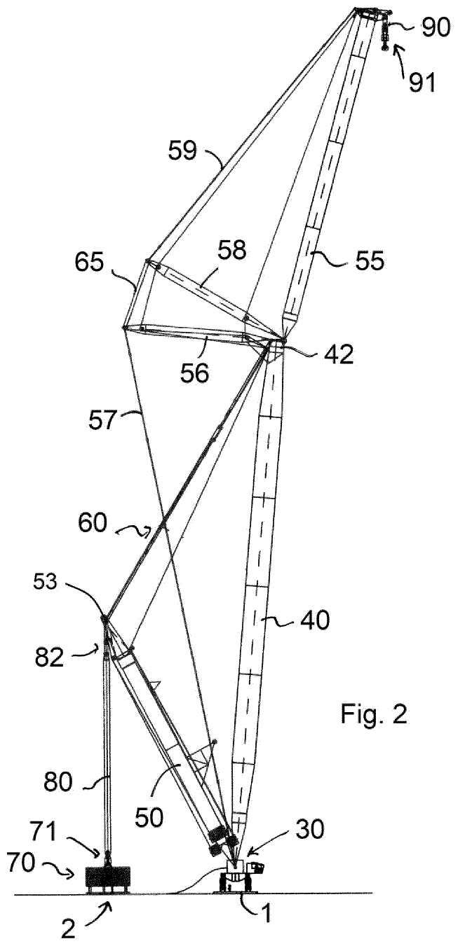

The FIGS. 1 and 2 show a heavy lift crane system that is installed at a hoisting site.

The crane system comprises a track arrangement installed on the ground. Here the track arrangement consists of a circular slew track assembly 1 that extends over a slew arc about a slew center 2. The slew track, for example, comprises a pair of track members, e.g. skid

The crane system further comprises a crane 20. The crane comprises:
a crane carriage, comprising a base 30, a first chassis 31 and second chassis 31, the first and second chassis being configured to travel over the track arrangement and to support the base 30 thereon,
a main boom 40, that is pivotal relative to the base of the crane carriage about a main boom pivot axis 41, and has a main boom tip 42,
a back mast 50, that is pivotal relative to the base 30 of the crane carriage about a back mast pivot axis 51, and has a back mast tip 52,
an adjustable length arrangement 60 between the back mast 50 and the main boom 40,
a counterweight 70, that is arranged at the slew center 2,
a connector strut 80 that suspends the counterweight 70 from the back mast 50. As is shown and is known in the art, the counterweight 70 may then still rest on the ground or another support.

The connector strut is pivotable relative to the back mast 50. The back mast has at its upper and a component suitable to engage with another component on the upper end of the connector strut. These two components form a pivotable connection and define a pivot axis 53.

A swivel 82 is provided between the counterweight 70 and the back mast 50 to allow for slew motion of the crane about the slew center 2, e.g. the swivel being integrated with the connector strut or with the connector 71 of the counterweight 70. In another embodiment, the counterweight 70 itself can revolve along with slew motion of the crane, e.g. mounted on a circular counterweight track.

The crane 20 is, for example, of use to production of wind turbines, e.g. that are to be installed by means of the crane 20 onto a floating foundation and then towed out to an offshore wind farm.

The depicted crane 20 is also provided with a jib 55, that is pivotally mounted to the tip of the main boom 50 as is known in the art. The jib 55 is kept in its desired orientation by a stay mechanism, here comprising a lower jib strut 56, a lower stay 57, and an upper jib strut 58, and an upper stay 59. As known in the art, the jib struts 56, 58 are each connected at an inner end to the tip of the main boom. A variable length mechanism 65 is present between the struts 56, 58.

It is illustrated that a hoist system of the crane 20 includes a winch driven hoist cable 90 that depends from a sheave assembly on the tip of the jib 55 in a multiple-fall arrangement to a hoisting block 91, e.g. with hook. For example, a further hoist system of the crane includes a winch driven hoist cable that depends from a sheave assembly on the tip of the main boom in a multiple-fall arrangement to a hoisting block, e.g. with hook.

In an embodiment, the crane is provided with a taglines system, e.g. including one or more tagline rails along the main boom on which one or more tagline trolleys travel, as is known in the art, e.g. in view of handling wind turbine blades.

As is known in the art, and as preferred, the tracks of the tracks of the circular slew track assembly may be embodied for skidding. For example, each track comprises a skid surface arranged between two skid rails, wherein skid actuators are engageable with one or both of said skid rails and with the carriage to advance the crane over the respective track. In another embodiment, the track engaging members are embodied as wheels that are configured to roll over a roll surface of the tracks, e.g. similar to railroad tracks.

The main boom 40 is, as is preferred, modular, more preferably with two latticed legs, e.g. as an A-frame as shown here.

The back mast 50 is, as is preferred, modular, more preferably with one or two latticed legs, e.g. as an A-frame as shown here.

The counterweight 70 may be composed of steel elements, e.g. that are arranged on a platform, in a cradle, etc. At the top of the counterweight 70 there is a connector 71 for the connector strut 80.

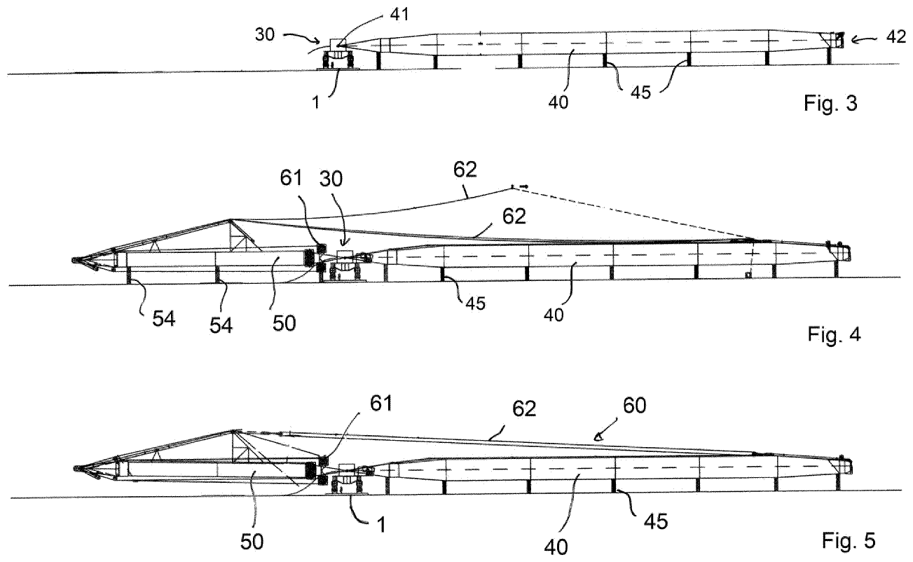

With reference to FIGS. 3-8 the relevant phases of the installation of the crane 20 will be discussed.

FIG. 3 illustrates the installing of the crane carriage 30 on the circular slew track assembly 1, and the assembly of the main boom 40 in horizontal orientation to the crane carriage 30. As shown the main boom 40 rests on ground supports 45 that keep the main boom at a distance (here of several meters) above the ground and in horizontal orientation.

For purpose of illustration of the scale, a person is shown on the track assembly 1 under the carriage.

FIG. 4 illustrates the assembly of the back mast 50 in horizontal orientation to the crane carriage 30, and providing the adjustable length arrangement 60 between the back mast 50 and the main boom 40. This arrangement 60 includes one or more winches 61 on the back mast 50 and one or more winch driven cables 62 that extend from the tip of the back mast 50 and are to be connected in this phase to the main boom 40. The back mast is resting on ground supports 54.

FIG. 5 illustrates tensioning the adjustable length arrangement 60 and removal of the supports 54 from underneath the still horizontal back mast 50 to clear an area for the connector strut 80.

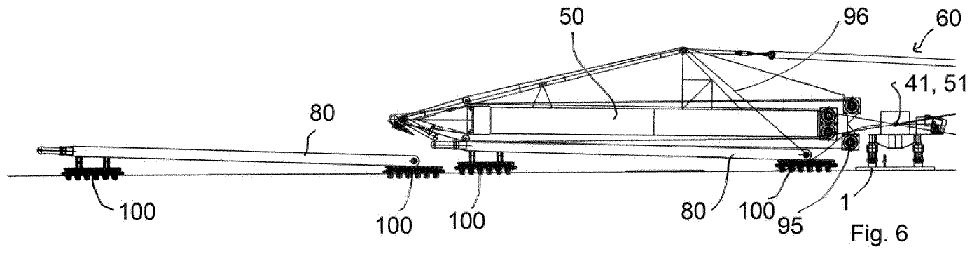

FIG. 6 illustrates the arranging of the connector strut 80 underneath the horizontal back mast 50. Here, two self-propelled modular transporters 100 are used to transport the strut 80 that rests thereon. Once positioned underneath the back mast 50, the upper end of the strut 80 is pivotally connected to the horizontal back mast.

The temporarily fastening of the strut 80 to the back mast, here involves the use of an auxiliary winch 95 of the crane system and a corresponding winch driven cable 96 that extends from the back mast 50 and that is attached to the connector strut 80 remote from its upper end, here at its lower end. The cable 96 is used to retain the connector strut 80 along the back mast, here to pull the connector strut towards, e.g. against, the back mast 50.

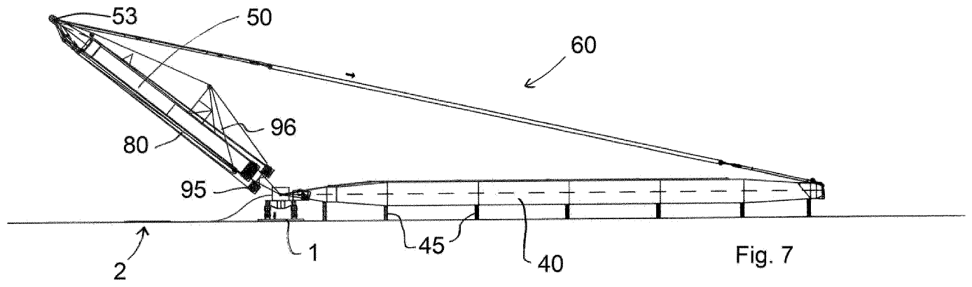

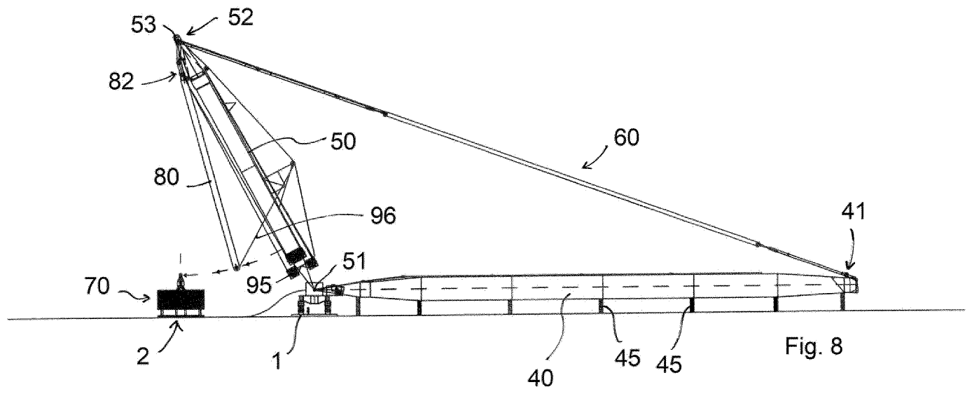

FIG. 7 illustrates the pivoting the back mast 50 as well as the temporarily fastened connector strut 80 into an inclined raised position by operating the adjustable length arrangement 60 between the back mast and the main boom 40. This clears the back mast from the slew center, so that now the counterweight 70 can be arranged at the slew center 2 as is shown in FIG. 8. The raised position of the back mast 50 the allows for the undoing of the temporarily fastening of the connector strut 80, and causing the connector strut 80 to swing to a substantially vertical orientation, followed by connecting a lower end of the connector strut to the counterweight. The swing of the strut 80 is here controlled by operation of the winch 95.

Once the connector strut 80 is secured to the counter weight, the main boom (here with jib) is raised by operating the adjustable length arrangement 60 between the back mast and the main boom 40. The crane system is now ready for use.

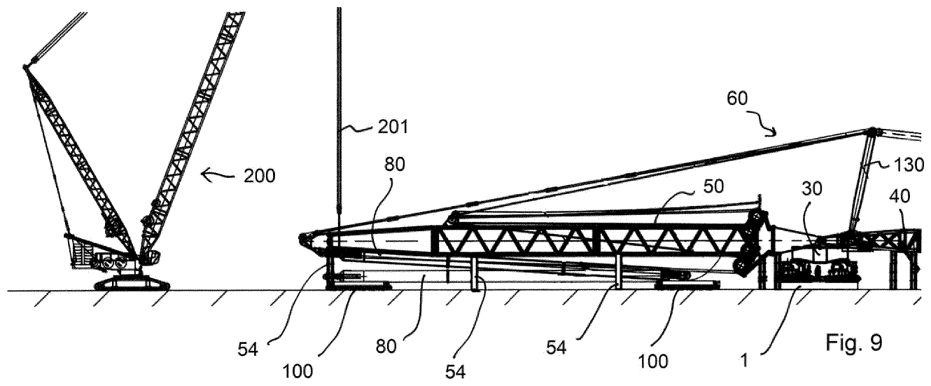

With reference to FIGS. 9-11 a second embodiment of the invention will now be discussed. Herein components have been indicated with the same reference numerals as in the first embodiment.

The FIG. 9 illustrates that the connector strut 80 is transported on two transporters 100 to a location underneath the horizontally oriented back mast 50, which rests on ground supports 54. The transporters 100 move in between the supports 54 so that the back mast 50 can remain supported thereon in this phase.

The FIG. 9 illustrates that the upper end of the connector strut 80 is lifted by means of a mobile crane 200 with hoist cable 201, so that the upper end of the strut 80 can be connected to the tip end 52 of the back mast. The lower end of the strut 80 remains on the transporter 100.

FIG. 9 illustrates that an auxiliary bracket 130 is employed to provide a lever for the arrangement 60 in the course of the following step of raising the back mast 50.

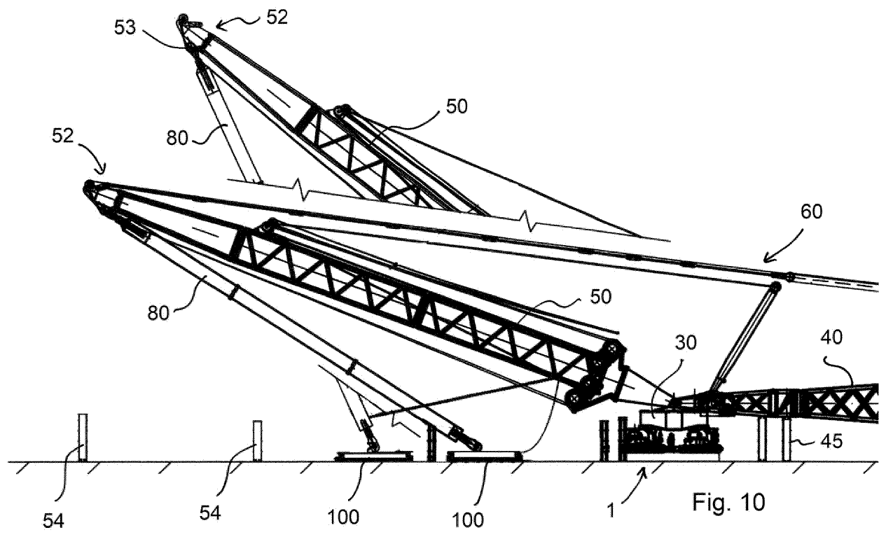

The raising of the back mast 50, whilst the strut 80 is connected thereto pivotally at its upper end, is illustrated in FIG. 10. It is shown that the connector strut 80 is supported at a lower end thereof by transporter 100. The raising step then comprises pivoting the back mast 50 into an inclined raised position, e.g. by operating the adjustable length arrangement 60 between the back mast and the main boom. Herein the lower end of the connector strut 80 initially remains supported by the transporter 100 that moves away from the slew track assembly 1 until the lower end of the connector strut is lifted off the transporter 100.

The FIG. 10 illustrates that—before pivoting the back mast 50 into the inclined raised position—the lower end of the connector strut 80 is connected via a sling 85 or cable to the back mast, thereby limiting the pivot angle of the connector strut 80 relative to the back mast. Initially the sling 85 is slack as shown in FIG. 10, but as the back mast is pivoted upwards and the transporter 100 moves away from the slew track assembly 1, the sling becomes taut as also shown in FIG. 10. When continuing the process step of raising the back mast 50, the lower end of the connector strut 80 is lifted off the transporter 100 as the sling 85 limits the pivot angle of the connector strut relative to the back mast 50.

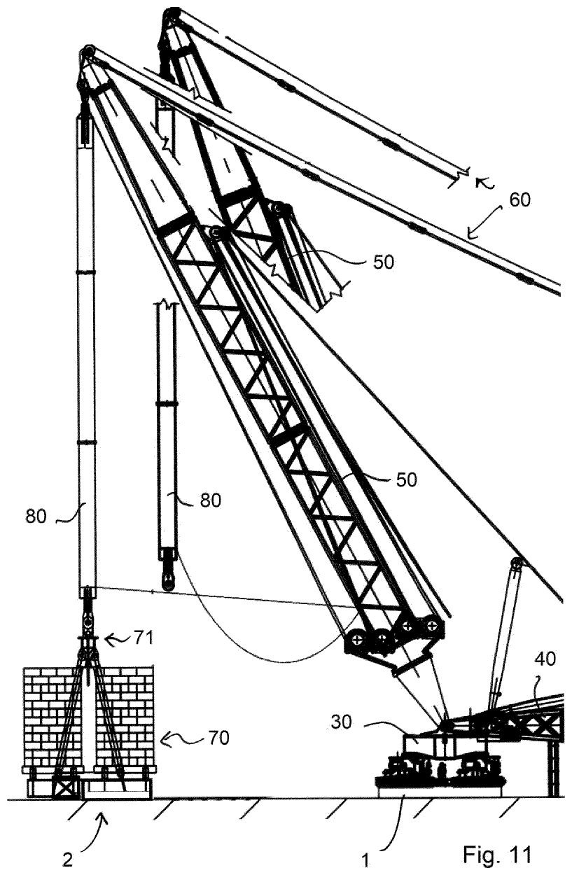

FIG. 11 illustrates the back mast 50 is raised to an inclination such that the depending connector strut 80 is well clear of the slew center 2 which allows for arranging the counterweight 70 at the slew center 2. Once the counterweight 70 is completed, the back mast 50 is lowered somewhat, as shown in FIG. 11, so that the connector strut is brought in a substantially vertical orientation above the counterweight. Then the lower end of the connector strut 80 is connected to connector 71 of the counterweight 70. In the further installation process, the main boom 40 can be raised by operating the adjustable length arrangement 60, e.g. a dedicated mechanism thereof, between the back mast and the main boom.

1.-12. (canceled)

13. A method for installing a heavy lift crane system at a hoisting site, the crane system comprising:
a track arrangement configured to be installed on the ground and comprising:
a circular slew track assembly extending over at least a slew arc about a slew center,
a crane comprising:
a crane carriage, comprising a base, a first chassis and second chassis, the first and second chassis being configured to travel over the track arrangement and to support the base thereon,
a main boom, that is pivotal relative to the base of the crane carriage about a main boom pivot axis, and has a main boom tip,
a back mast, that is pivotal relative to the base of the crane carriage about a back mast pivot axis, and has a back mast tip,
an adjustable length arrangement between the back mast and the main boom,
a counterweight, that is configured to be arranged at the slew center,
wherein the crane comprises a connector strut to suspend the counterweight from the back mast, and wherein a swivel is provided between the counterweight and the back mast to allow for slew motion of the crane about the slew center,
wherein the method comprises:
installing the circular slew track assembly at the hoisting site,
assembly of the crane comprising:
installing the crane carriage on the track arrangement,
assembly of the main boom in horizontal orientation to the crane carriage,
assembly of the back mast in horizontal orientation to the crane carriage,
providing the adjustable length arrangement between the back mast and the main boom,
arranging the connector strut, in a horizontal orientation, underneath the horizontal back mast,
pivotally connecting an upper end of the connector strut to the horizontal back mast,
pivoting the back mast into an inclined raised position with the connector strut being pivotally connected at its upper end to the back mast via a strut pivot axis,
arranging the counterweight at the slew center,
bringing the connector strut above the counterweight,
connecting a lower end of the connector strut to the counterweight,
raising the main boom.

14. The method according to claim 13, wherein, after pivotally connecting the upper end of the connector strut to the horizontal back mast, the connector strut temporarily fastened along the back mast, and wherein the method then comprises:
pivoting the back mast with the connector strut that has been temporarily fastened thereto into an inclined raised position,
arranging the counterweight at the slew center,
undoing the temporarily fastening of the connector strut and causing the connector strut to swing into a substantially vertical orientation above the counterweight,
connecting a lower end of the connector strut to the counterweight,
raising the main boom.

15. The method according to claim 13, wherein, after pivotally connecting the upper end of the connector strut to the horizontal back mast, the connector strut is supported at a lower end thereof by a vehicle, and wherein the method then comprises:
pivoting the back mast into an inclined raised position, wherein the lower end of the connector strut initially remains supported by the vehicle that moves away from the slew track assembly until the lower end of the connector strut is lifted off the vehicle,
arranging the counterweight at the slew center,
bringing the connector strut in a substantially vertical orientation above the counterweight,
connecting the lower end of the connector strut to the counterweight,
raising the main boom.

16. The method according to claim 15, wherein, before pivoting the back mast into the inclined raised position, the lower end of the connector strut is connected via a sling or cable to the back mast, thereby limiting the pivot angle of the connector strut relative to the back mast, and wherein the method then comprises:
pivoting the back mast into an inclined raised position, wherein the lower end of the connector strut initially remains supported by the vehicle that moves away from the slew track assembly until the lower end of the connector strut is lifted off the vehicle as the sling or cable limits the pivot angle of the connector strut,
arranging the counterweight at the slew center,
bringing the connector strut in a substantially vertical orientation above the counterweight,
connecting the lower end of the connector strut to the counterweight,
raising the main boom.

17. The method according to claim 13, wherein the horizontal main boom rests on ground supports that hold the main boom horizontal and at a distance above the ground, or wherein the horizontal back mast rests on ground supports that hold the back mast horizontal and at a distance above the ground.

18. The method according to claim 13, wherein the horizontal main boom rests on ground supports that hold the main boom horizontal and at a distance above the ground and wherein the horizontal back mast rests on ground supports that hold the back mast horizontal and at a distance above the ground.

19. The method according to claim 18, wherein the assembly of the main boom takes place on the ground supports, and wherein the assembly of the back mast takes place on the ground supports.

20. The method according to claim 13, wherein, before moving or assembling the connector strut underneath the back mast, ground supports upon which the back mast rests are first removed or displaced to clear an area for the connector strut.

21. The method according to claim 20, wherein the connector strut is transported on one or more vehicles.

22. The method according to claim 20, wherein the adjustable length arrangement is operated so that the back mast no longer rests on the ground supports and is effectively suspended, in horizontal position, by the adjustable length arrangement, the ground supports then be displaced or removed to clear an area under the horizontal back mast for the connector strut.

23. The method according to claim 14, wherein the temporarily fastening involves the use of an auxiliary winch of the crane system and a corresponding winch driven cable that extends from the back mast and that is attached to the connector strut remote from its upper end, wherein the cable is used to retain the connector strut along the back mast.

24. The method according to claim 23, wherein the cable is used to pull the connector strut against the back mast.

25. The method according to claim 13, wherein an auxiliary winch and corresponding cable is employed to cause a controlled pivotal motion of the connector strut relative to the back mast.

26. A heavy lift crane system to be installed at a hoisting site, the crane system comprising:
a track arrangement configured to be installed on the ground and comprising:
a circular slew track assembly extending over at least a slew arc about a slew center,
a crane comprising:
a crane carriage, comprising a base, a first chassis and second chassis, the first and second chassis being configured to travel over the track arrangement and to support the base thereon,
a main boom, that is pivotal relative to the base of the crane carriage about a main boom pivot axis, and has a main boom tip,
a back mast, that is pivotal relative to the base of the crane carriage about a back mast pivot axis, and has a back mast tip,
an adjustable length arrangement between the back mast and the main boom,
a counterweight, that is configured to be arranged at the slew center,
wherein the crane comprises a connector strut to suspend the counterweight from the back mast,
which connector strut is, in an installation configuration, arranged horizontally underneath the back mast in a horizontal orientation of the back mast, and is pivotally connected to the back mast, and pivotal about a back mast upper end pivot axis,
wherein the upper end of the connector strut, in an operational configuration, is pivotally connected to the back mast, in a substantially vertical orientation and wherein the counterweight is connected to a lower end of the connector strut and thereby suspended from the back mast.

27. The heavy lift crane system according to claim 26, wherein temporarily fastening means are provided for temporarily fastening the connector strut along the horizontal back mast, allowing to pivot the back mast and the connector strut that has been temporarily fastened thereto into an inclined raised position.

28. The heavy lift crane system according to claim 27, wherein the connector strut is temporarily fastened along the horizontal back mast by operating the adjustable length arrangement between the back mast and the main boom.

29. The heavy lift crane system according to claim 27, wherein the temporarily fastening means comprise an auxiliary winch of the crane system and a corresponding winch driven cable that extends from the back mast and that can be attached to the connector strut remote from its upper end.
